(19) United States
(12) Patent Application Publication
(10) Pub. No.: US 2026/0246947 A1
(43) Pub. Date: Aug. 20, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); Kia Corporation, Seoul (KR)

(72) Inventors: Jin HEO, Hwaseong-si, Gyeonggi-do (KR); Jungah CHOI, Hwaseong-si, Gyeonggi-do (KR); Seung Wook PARK, Hwaseong-si, Gyeonggi-do (KR)

(73) Assignees: HYUNDAI MOTOR COMPANY, Seoul (KR); Kia Corporation, Seoul (KR)

(21) Appl. No.: 19/470,683

(22) PCT Filed: Jun. 25, 2024
(86) PCT No.: PCT/KR2024/008770

§ 371 Date: Sep. 29, 2025

(30) Foreign Application Priority Data
Jun. 26, 2023 (KR) 10-2023-0082098
Jun. 25, 2024 (KR) 10-2024-0082455

(51) Int. Cl. H04N 19/159; H04N 19/105; H04N 19/176; H04N 19/196; H04N 19/54

(52) U.S. Cl. CPC H04N 19/159; H04N 19/105; H04N 19/176; H04N 19/196; H04N 19/54

(57) ABSTRACT

An image decoding method may comprise determining a prediction mode of a current block as an affine intra prediction mode, determining a control point block vector of the current block, determining block vectors of sub-blocks of the current block based on the control point block vector of the current bloc, and predicting the current block using reference blocks of a current picture indicated by the block vectors of the sub-blocks.

### TECHNICAL FIELD

The present invention relates to an image encoding/decoding method and apparatus and a recording medium for storing a bitstream. More particularly, the present invention relates to an image encoding/decoding method and apparatus using an intra prediction method and a recording medium for storing a bitstream.

### BACKGROUND ART

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In video encoding and decoding, intra prediction is a technique for predicting a current block using previously reconstructed reference pixels of a current picture. At this time, according to intra prediction, a prediction block is generated from the reference pixels of the current picture based on a predetermined non-directional mode, directional mode, intra block copy mode, etc. Intra prediction may have lower prediction accuracy than inter prediction, which may limit encoding efficiency. Therefore, various methods for improving the prediction accuracy of intra prediction are being discussed.

### DISCLOSURE

### Technical Problem

An object of the present invention is to provide a method and apparatus for encoding/decoding an image with improved encoding/decoding efficiency.

Another object of the present invention is to provide a recording medium for storing a bitstream that is generated by generated by a method or apparatus for decoding an image, which is provided in the present invention.

### Technical Solution

An image decoding method according to an embodiment of the present invention may comprise determining a prediction mode of a current block as an affine intra prediction mode, determining a control point block vector of the current block, determining block vectors of sub-blocks of the current block based on the control point block vector of the current bloc, and predicting the current block using reference blocks of a current picture indicated by the block vectors of the sub-blocks.

According to one embodiment, the image decoding method may further comprise generating an affine control point block vector predictor candidate list of the current block when the determined affine intra prediction mode is an affine intra prediction mode using block vector prediction, and the control point block vector of the current block may be determined from a control point block vector predictor selected from the affine control point block vector predictor candidate list of the current block.

According to one embodiment, the affine control point block vector predictor candidate list may include inherited predictor candidates derived from a neighboring block, to which affine intra prediction is applied, among neighboring blocks of the current block.

According to one embodiment, the affine control point block vector predictor candidate list may include combined predictor candidates derived from a combination of block vectors of a plurality of neighboring blocks of the current block.

According to one embodiment, the affine control point block vector predictor candidate list may include a translational motion vector candidate derived from the block vector of the neighboring block of the current block if the number of inherited predictor candidates and combined predictor candidates is less than a maximum number of the affine control point block vector predictor candidate list.

According to one embodiment, the image decoding method may further comprise deriving a control point block vector difference value, and the control point block vector of the current block may be determined based on the selected control point block vector predictor and the control point block vector difference value.

According to one embodiment, the image decoding method may further comprise generating an affine intra merge list of the current block if the determined affine intra prediction mode is an affine intra prediction mode using merge, and the control point block vector of the current block may be determined from a control point block vector selected from the affine intra merge list of the current block.

According to one embodiment, the affine intra merge list may include inherited predictor candidates derived from a neighboring block, to which affine intra prediction is applied, among neighboring blocks of the current block.

According to one embodiment, the affine intra merge list may include combined predictor candidates derived from a combination of block vectors of a plurality of neighboring blocks of the current block.

According to one embodiment, the affine intra merge list may include translational motion vector candidates derived from the block vector of the neighboring block of the current block if the number of inherited predictor candidates and combined predictor candidates is less than a maximum number of the affine intra merge list.

According to one embodiment, if the determined affine intra prediction mode is a simple affine intra prediction mode, the control point block vector of the current block may be derived from a plurality of adjacent blocks of the current block.

According to one embodiment, the control point block vector of the current block may be derived from an adjacent block having a block vector among adjacent blocks adjacent to a control point of the control point block vector of the current block, and if the number of adjacent blocks having the block vector is greater than 1, the control point block vector of the current block may be derived according to a block vector of an adjacent block having a high priority according to a predetermined search order.

According to one embodiment, the control point block vector of the current block may be derived from an adjacent block, to which an affine intra prediction mode is applied, among adjacent blocks adjacent to a control point of the control point block vector of the current block, and if the number of adjacent blocks to which the affine intra prediction mode is applied is greater than 1, the control point block vector of the current block may be derived according to a block vector of a sub-block of an adjacent block of a high priority according to a predetermined search order.

According to one embodiment, if there is an adjacent block to which the affine intra prediction mode is applied or an adjacent block having a block vector among the adjacent blocks adjacent to the control point of the control point block vector of the current block, the control point block vector of the current block may be determined to be available, and wherein if there is neither an adjacent block to which the affine intra prediction mode is applied nor an adjacent block having a block vector among the adjacent blocks adjacent to the control point of the control point block vector of the current block, the control point block vector of the current block may be determined to be unavailable.

According to one embodiment, if there are two available control point block vectors, the current block may be predicted according to a 4-parameter affine model according to the two control point block vectors, and if there are three available control point block vectors, the current block may be predicted according to a 6-parameter affine model according to the three control point block vectors.

According to one embodiment, if there is one or less available control point block vectors, it may be determined that the affine intra prediction mode is not applied to the current block.

An image encoding method according to an embodiment of the present invention may comprise determining a prediction mode of a current block as an affine intra prediction mode, determining a control point block vector of the current block, determining block vectors of sub-blocks of the current block based on the control point block vector of the current block, and predicting the current block using reference blocks of a current picture indicated by the block vectors of the sub-blocks.

A non-transitory computer-readable recording medium according to an embodiment of the present invention may store a bitstream generated by the image encoding method.

A transmission method according to an embodiment of the present invention transmits a bitstream generated by the image encoding method.

The features briefly summarized above with respect to the present disclosure are merely exemplary aspects of the detailed description below of the present disclosure, and do not limit the scope of the present disclosure.

### Advantageous Effects

The present invention proposes various embodiments of an affine intra prediction mode using block vector prediction or merge.

In addition, the present invention proposes various embodiments of a simple affine intra prediction mode.

According to the various embodiments, the overall encoding efficiency can be improved as the prediction accuracy of the intra prediction mode is improved.

### DESCRIPTION OF DRAWINGS

FIG. 1 is a block diagram showing a configuration of an encoding apparatus an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 shows a CPMV-based affine motion model for affine inter prediction.

FIG. 5 shows a CPBV-based affine motion model for affine intra prediction.

FIG. 6 shows the positions of the neighboring blocks of a current block that are referenced in deriving CPBVP candidates according to an inheritance method.

FIG. 7 is a diagram for explaining a method of deriving a CPBVP candidate of a current block from a CPBV of a neighboring block according to an inheritance method.

FIG. 8 illustrates the positions of neighboring blocks of a current block that are referenced in deriving a CPBVP candidate according to a combination method.

FIG. 9 illustrates a CPBV determination method for a simple affine intra prediction.

FIG. 10 illustrates an embodiment of an intra prediction method to which intra prediction mode improvement is applied.

FIG. 11 exemplarily illustrates a content streaming system to which an embodiment according to the present invention is applicable.

### BEST MODE

An image decoding method according to an embodiment of the present invention may comprise determining a prediction mode of a current block as an affine intra prediction mode, determining a control point block vector of the current block, determining block vectors of sub-blocks of the current block based on the control point block vector of the current bloc, and predicting the current block using reference blocks of a current picture indicated by the block vectors of the sub-blocks.

### MODE FOR INVENTION

The present disclosure may have various modifications and embodiments, and specific embodiments are illustrated in the drawings and described in detail in the detailed description. However, this is not intended to limit the present disclosure to specific embodiments, but should be understood to include all modifications, equivalents, or substitutes included in the spirit and technical scope of the present disclosure. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present disclosure with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present disclosure, the terms first, second, etc. may be used to describe various components, but the components should not be limited by the terms. The terms are only used for the purpose of distinguishing one component from another. For example, without departing from the scope of the present disclosure, the first component may be referred to as the second component, and similarly, the second component may also be referred to as the first component. The term is and/or includes a combination of a plurality of related described items or any item among a plurality of related described items.

The components shown in the embodiments of the present disclosure are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present disclosure as long as they do not deviate from the essence of the present disclosure.

The terminology used in the present disclosure is only used to describe specific embodiments and is not intended to limit the present disclosure. The singular expression includes the plural expression unless the context clearly indicates otherwise. In addition, some components of the present disclosure are not essential components that perform essential functions in the present disclosure and may be optional components only for improving performance. The present disclosure may be implemented by including only essential components for implementing the essence of the present disclosure excluding components only used for improving performance, and a structure including only essential components excluding optional components only used for improving performance is also included in the scope of the present disclosure.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present disclosure will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

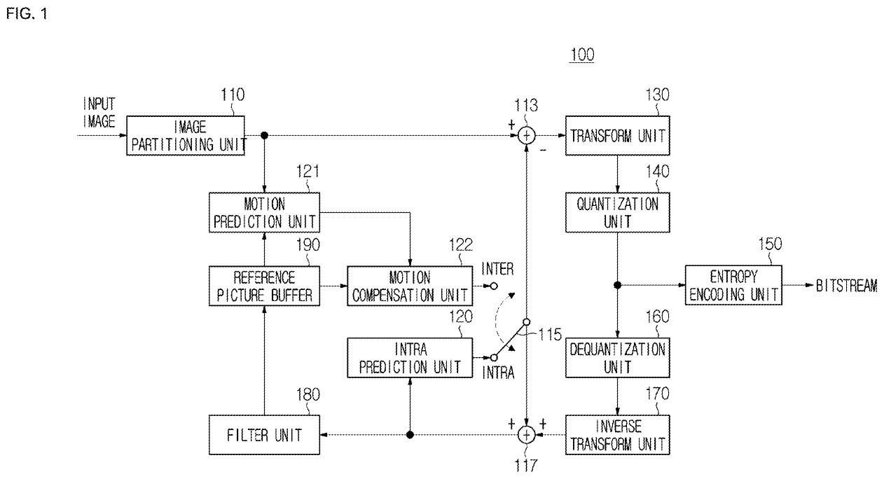

FIG. 1 is a block diagram showing a configuration of an encoding apparatus according to an embodiment of the present disclosure.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present disclosure, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

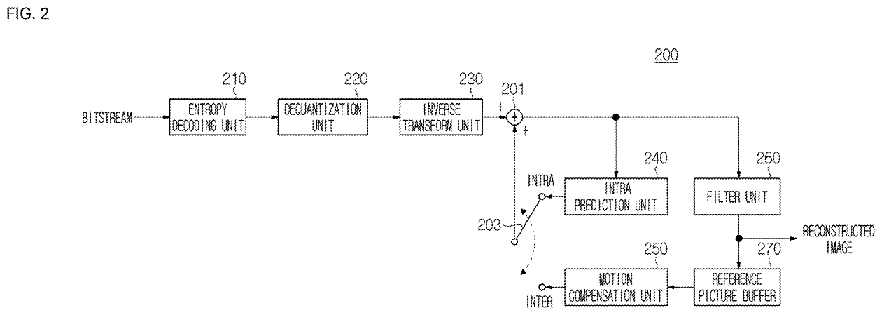

FIG. 2 is a block diagram showing a configuration of a decoding apparatus according to an embodiment of the present disclosure.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

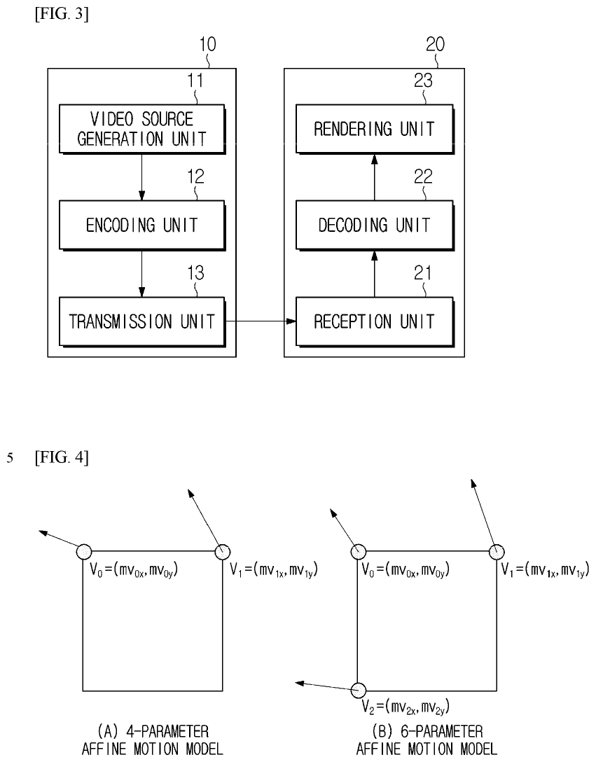

FIG. 3 is a diagram schematically showing a video coding system to which the present disclosure is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

The present disclosure describes an affine intra prediction method that extends a prediction technique according to an affine model used in inter prediction to intra prediction. By combining an intra block copy (IBC) mode or an intra template matching prediction (IntraTMP) mode of intra prediction with a prediction technique according to an affine model, the accuracy of intra prediction can be improved.

Hereinafter, various embodiments of the affine intra prediction method will be described.

Affine motion compensation prediction is used to efficiently code video signals including motions such as zoom, rotation, and shear. When motions such as zoom and rotation are included, affine motion compensation prediction may be performed according to a 4-parameter affine motion model using two control point motion vectors (CPMVs). In addition, when motions such as zoom, rotation, and shear are included, affine motion compensation prediction may be performed according to a 6-parameter affine motion model using three CPMVs.

FIG. 4 shows a CPMV-based affine motion model for affine inter prediction. (a) of FIG. 4 shows a 4-parameter affine motion model using two CPMVs (v₀, v₁). In addition, (b) of FIG. 4 shows a 6-parameter affine motion model using three CPMVs (v₀, v₁, v₂).

According to the 4-parameter affine motion model, the motion vector (mvₓ, mv_{y}) at the (x, y) pixel position of the current block may be derived based on Equation 1. In Equation 1, W represents the width of the current block.

$${mv}_{x} = \frac{{mv}_{1 x} - {mv}_{0 x}}{W} x + \frac{{mv}_{1 y} - {mv}_{0 y}}{W} y + {mv}_{0 x} \qquad [ Equation 1 ]$$

$${mv}_{y} = \frac{{mv}_{1 y} - {mv}_{0 y}}{W} x + \frac{{mv}_{1 x} - {mv}_{0 x}}{W} y + {mv}_{0 y}$$

According to the 6-parameter affine motion model, the motion vector (mvₓ, mv_{y}) at the (x, y) pixel position of the current block may be derived based on Equation 2. In Equation 2, W and H represent the width and height of the current block, respectively.

$${mv}_{x} = \frac{{mv}_{1 x} - {mv}_{0 x}}{W} x + \frac{{mv}_{2 x} - {mv}_{0 x}}{H} y + {mv}_{0 x} \qquad [ Equation 2 ]$$

$${mv}_{y} = \frac{{mv}_{1 y} - {mv}_{0 y}}{W} x + \frac{{mv}_{2 y} - {mv}_{0 y}}{H} y + {mv}_{0 y}$$

As above, an affine motion model is derived from multiple CPMVs at predetermined positions associated with the current block. Then, a motion vector (MV) may be calculated for all pixels in the current block based on the derived affine motion model.

Motion prediction and motion compensation to which pixel unit motion vectors are applied have high complexity. Therefore, the motion vector may be calculated in units of sub-blocks of the current block. At this time, the same motion vector is applied to all pixels of the sub-block. When the motion vector is calculated in units of sub-blocks, the current block may be divided into sub-blocks with a size of M×N. Here, M and N are each an arbitrary positive integer greater than or equal to 1. The size of the sub-block may be fixed to a specific size, but may also be adaptively determined based on the block size, etc. The motion vector of each sub-block may be derived according to the affine motion model based on a predetermined position of each sub-block. The predetermined position may be the top-left position, the middle position, the bottom-right position, etc. of each sub-block. Motion prediction of each sub-block may be performed based on the derived motion vector.

According to one embodiment, affine intra prediction may be performed based on an affine motion model derived based on a control point block vector (CPBV).

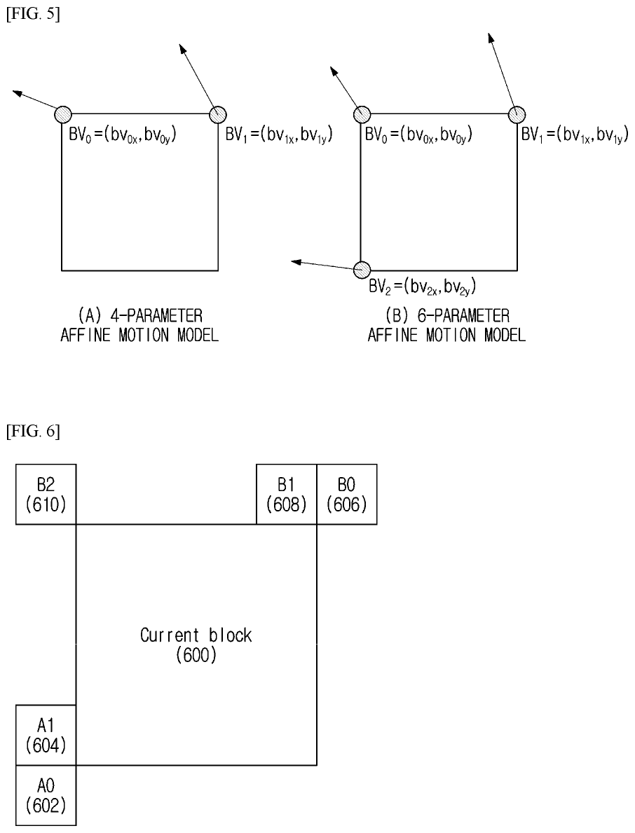

FIG. 5 shows a CPBV-based affine motion model for affine intra prediction. (a) of FIG. 5 shows a 4-parameter affine motion model using two CPBVs (BV₀, BV₁). In addition, (b) of FIG. 5 shows a 6-parameter affine motion model using three CPBVs (BV₀, BV₁, BV₂).

According to the 4-parameter affine motion model, the block vector (bvₓ, bv_{y}) at the (x, y) pixel position of the current block may be derived based on Equation 3. In Equation 3, W represents the width of the current block.

$${bv}_{x} = \frac{{bv}_{1 x} - {bv}_{0 x}}{W} x + \frac{{bv}_{1 y} - {bv}_{0 y}}{W} y + {bv}_{0 x} \qquad [ Equation 3 ]$$

$${bv}_{y} = \frac{{bv}_{1 y} - {bv}_{0 y}}{W} x + \frac{{bv}_{1 x} - {bv}_{0 x}}{W} y + {bv}_{0 y}$$

According to the 6-parameter affine motion model, the block vector (bvₓ, bv_{y}) at the (x, y) pixel position of the current block may be derived based on Equation 4. In Equation 4, W and H represent the width and height of the current block, respectively.

$${bv}_{x} = \frac{{bv}_{1 x} - {bv}_{0 x}}{W} x + \frac{{bv}_{2 x} - {bv}_{0 x}}{H} y + {bv}_{0 x} \qquad [ Equation 4 ]$$

$${bv}_{y} = \frac{{bv}_{1 y} - {bv}_{0 y}}{W} x + \frac{{bv}_{2 y} - {bv}_{0 y}}{H} y + {bv}_{0 y}$$

As above, an affine motion model is derived from multiple CPBVs at predetermined positions associated with the current block. Then, based on the derived affine motion model, a block vector (BV) may be calculated for all pixels in the current block.

Motion prediction and motion compensation to which pixel unit block vectors are applied have high complexity. Therefore, block vectors are calculated in units of sub-blocks with a size of M×N, and motion prediction and motion compensation of each sub-block may be performed according to the calculated block vector of the sub-block. That is, the current block is divided into sub-blocks with a size of M×N, and a block vector is derived based on an affine motion model at a predetermined position of each sub-block, so that motion prediction and compensation may be performed for each sub-block. Here, M and N are each an arbitrary positive integer greater than or equal to 1. The size of the sub-block may be fixed to a specific size, but may also be adaptively determined based on the block size, etc. The predetermined position may be the top-left position, the middle position, the bottom-right position, etc. of each sub-block. Motion prediction of each sub-block may be performed based on the derived motion vector.

According to one embodiment, a CPBV representing an affine motion model of a current block may be derived based on a block vector in an intra block copy (IBC) mode or a block vector in an intra template matching prediction (IntraTMP) mode.

According to one embodiment, a method similar to the CPMV determination method applied in the affine inter mode or the affine merge mode may be applied to determine the CPBV used in the affine intra prediction.

Hereinafter, an affine intra prediction method using block vector prediction according to one embodiment will be described. Hereinafter, the prediction method is called an affine block vector prediction mode.

When the affine block vector prediction mode is applied to the current block, an affine model flag indicating whether to additionally use a 4-parameter affine motion model or a 6-parameter affine motion model may be encoded/decoded. In the affine block vector prediction mode, a CPBVP candidate list including at most S CPBV prediction (control point block vector predictor, CPBVP) candidates may be constructed using neighboring blocks of the current block.

Here, S is any positive integer. The CPBVP candidates may be constructed according to an inheritance method and/or a combination method. In addition, the CPBVP candidates may include two or three CPBVs according to the affine motion model.

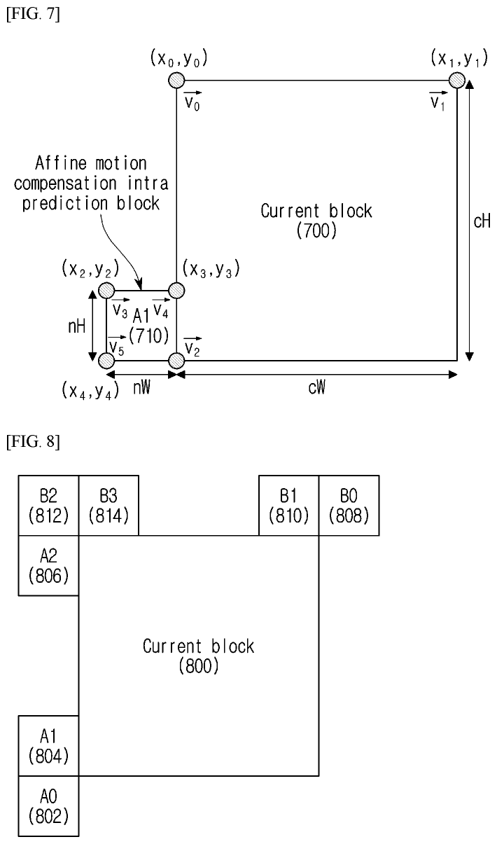

Hereinafter, a method of constructing a CPBVP candidate list according to an inheritance method according to one embodiment will be described based on FIGS. 6 and 7.

According to one embodiment, neighboring blocks of a current block may be searched in a predetermined order. In addition, based on the CPBV of the neighboring block which is an affine intra prediction mode among the searched neighboring blocks, the CPBVP candidates of the current block may be derived. At most S CPBVP candidates may be derived by the inheritance method. In addition, the derived CPBVP candidates may be included in the CPBVP candidate list in the predetermined order. Hereinafter, neighboring blocks referenced in the CPBVP candidate list will be described with reference to FIG. 6.

FIG. 6 shows the positions of neighboring blocks 602, 604, 606, 608 and 610 of a current block 600 that are referenced in deriving CPBVP candidates according to an inheritance method.

According to one embodiment, the neighboring blocks of a current block 600 may be searched in the order of A0 block 602 and A1 block 604 of FIG. 6. Then, a CPBVP candidate may be derived from a block on which affine intra prediction is performed among A0 block 602 and A1 block 604. Depending on the embodiment, unlike FIG. 6, A1 block 604 may be located directly below B2 block 610 or halfway between A0 block 602 and B2 block 610. Also, depending on the embodiment, the neighboring blocks of the current block 600 may be searched as A1 block 604 and A0 block 602.

According to one embodiment, the neighboring blocks of the current block 600 may be searched in the order of B0 block 606, B1 block 608, and B2 block 610 of FIG. 6. Then, a CPBVP candidate may be derived from a block on which affine intra prediction is performed among B0 block 606, B1 block 608, and B2 block 610. Depending on the embodiment, unlike FIG. 6, B1 block 608 may be located immediately to the right of B2 block 610 or halfway between B0 block 606 and B2 block 610. Also, depending on the embodiment, the neighboring blocks of the current block 600 may be searched in the order of B2 block 610, B1 block 608, and B0 block 606.

According to one embodiment, conditions of neighboring blocks for deriving CPBVP candidates may be set in various ways depending on the number of candidates in the CPBVP candidate list. For example, if the number of candidates in the CPBVP candidate list is 2, one left CPBVP candidate may be derived from A0 block 602 and A1 block 604 on the left side of the current block 600, and one upper CPBVP candidate may be derived from B0 block 606, B1 block 608, and B2 block 610 on the upper side of the current block 600. In this case, if affine intra prediction is performed on both A0 block 602 and A1 block 604, the left CPBVP candidate may be derived from a block searched first in a predetermined order among A0 block 602 and A1 block 604. In addition, if affine intra prediction is performed on two or more blocks among 0 block 606, B1 block 608, and B2 block 610, the upper CPBVP candidate may be derived from the block searched first in a predetermined order among B0 block 606, B1 block 608, and B2 block 610.

According to another embodiment, if the number of candidates in the CPBVP candidate list is 3 or more, the CPBVP candidate list may be constructed in a predetermined order using the CPBVs of the blocks on which affine intra prediction is performed among A0 block 602, A1 block 604, B0 block 606, B1 block 608, and B2 block 610. At this time, the number, position, and search order of the neighboring blocks of the current block used may be arbitrarily determined.

FIG. 7 is a diagram for explaining a method of deriving a CPBVP candidate of a current block from a CPBV of a neighboring block according to an inheritance method.

If A1 block 710 of a current block 700 is subjected to affine intra prediction as shown in FIG. 7, the CPBVP candidate of the current block 700 may be derived from the CPBV of the A1 block 710 according to Equation 5 or Equation 6. When a 4-parameter affine motion model is applied to the current block 700, CPBVP (v₀ₓ, v_{0y}) at the top-left position and CPBVP (v₁ₓ, v_{1y}) at the top-right position may be derived according to Equation 5. If a 6-parameter affine motion model is applied to the current block 700, CPBVP (v₀ₓ, v_{0y}) at the top-left position, CPBVP (v₁ₓ, v_{1y}) at the top-right position, and CPBVP (v₂ₓ, v_{2y}) at the bottom-left position may be derived according to Equation 6.

$${v}_{0 x} = {v}_{3 x} + \frac{( {v}_{4 x} - {v}_{3 x} ) ( {x}_{0} - {x}_{3} )}{nW} + \frac{( {v}_{3 y} - {v}_{4 y} ) ( {y}_{0} - {y}_{3} )}{nH} \qquad [ Equation 5 ]$$

$${v}_{0 y} = {v}_{3 y} + \frac{( {v}_{4 y} - {v}_{3 y} ) ( {x}_{0} - {x}_{3} )}{nW} + \frac{( {v}_{4 x} - {v}_{3 x} ) ( {y}_{0} - {y}_{3} )}{nH}$$

$${v}_{1 x} = {v}_{0 x} + \frac{( {v}_{4 x} - {v}_{3 x} )}{nW} \times cW$$

$${v}_{1 y} = {v}_{0 y} + \frac{( {v}_{4 y} - {v}_{3 y} )}{nW} \times cW$$

$${v}_{0 x} = {v}_{3 x} + \frac{( {v}_{4 x} - {v}_{3 x} ) ( {x}_{0} - {x}_{3} )}{nW} + \frac{( {v}_{5 x} - {v}_{3 x} ) ( {y}_{0} - {y}_{3} )}{nH} \qquad [ Equation 6 ]$$

$${v}_{0 y} = {v}_{3 y} + \frac{( {v}_{4 y} - {v}_{3 y} ) ( {x}_{0} - {x}_{3} )}{nW} + \frac{( {v}_{5 y} - {v}_{3 y} ) ( {y}_{0} - {y}_{3} )}{nH}$$

$${v}_{1 x} = {v}_{0 x} + \frac{( {v}_{4 x} - {v}_{3 x} )}{nW} \times cW$$

$${v}_{1 y} = {v}_{0 y} + \frac{( {v}_{4 y} - {v}_{3 y} )}{nW} \times cW$$

$${v}_{2 x} = {v}_{0 x} + \frac{( {v}_{5 x} - {v}_{3 x} )}{nH} \times cH$$

$${v}_{2 y} = {v}_{0 y} + \frac{( {v}_{5 y} - {v}_{3 y} )}{nH} \times cH$$

In Equation 5 and Equation 6, cW and cH represent the width and height of the current block 700, respectively. In addition, nW and nH represent the width and height of the neighboring block 710 to which the affine intra prediction of the current block 700 is applied.

Hereinafter, a method of constructing a CPBVP candidate list according to a combination method according to an embodiment will be described based on FIG. 8.

According to one embodiment, a CPBVP candidate may be generated by combining block vectors of neighboring blocks of a current block. The combination method may be performed when a list of at most S CPBVP candidates cannot be filled with CPBVP candidates generated by an inheritance method.

FIG. 8 illustrates the positions of neighboring blocks 802, 804, 806, 808, 810, 812 and 814 of a current block 800 that are referenced in deriving a CPBVP candidate according to a combination method.

According to one embodiment, in order to determine CPBV1, the presence of block vectors may be searched in the order of B2 block 812, B3 block 814, and A2 block 806 from the top-left of the current block 800. Then, as a result of the search, the block vector of the first block in the order among the blocks in which the block vector exists may be determined as CPBV1. At this time, the order of the blocks searched may be determined differently depending on the embodiment.

In order to determine CPBV2, the presence of block vectors may be searched in the order of B1 block 810 and B0 block 808 from the top-right of the current block 800. Then, as a result of the search, the block vector of the first block in the order among the blocks in which the block vector exists may be determined as CPBV2. At this time, the order of the blocks searched may be determined differently depending on the embodiment.

In order to determine CPBV3, the existence of block vectors may be searched in the order of A1 block 804 and A0 block 802 from the bottom-left of the current block 800. Then, as a result of the search, the block vector of the first block in the order among the blocks in which the block vector exists may be determined as CPBV3. At this time, the order of the blocks searched may be determined differently depending on the embodiment.

When the current block is predicted according to a 4-parameter affine motion model, a CPBVP candidate may be generated by combining {CPBV1, CPBV2}. When the current block is predicted according to a 6-parameter affine motion model, a CPBVP candidate may be generated by combining {CPBV1, CPBV2, CPBV3}.

If the number of prediction candidates of the CPBVP candidate list generated using the above inheritance method and combination method is less than S, the missing translational motion vector candidates may be generated using CPBV1, CPBV2 and/or CPBV3 to fill the CPBVP candidate list. For example, when a 4-parameter affine motion model is used for the current block, {CPBV1, CPBV1}, {CPBV2, CPBV2} and {CPBV3, CPBV3} may be sequentially added to the CPBVP candidate list. In addition, a 6-parameter affine motion model is used for the current block, {CPBV1, CPBV1, CPBV1}, {CPBV2, CPBV2, CPBV2} and {CPBV3, CPBV3, CPBV3} may be sequentially added to the CPBVP candidate list. The order of the added translational motion vector candidates may be arbitrarily changed.

If the number of prediction candidates in the CPBVP candidate list is less than S even though the translational motion vector candidate is added to the CPBVP candidate list, one or more default block vectors may be added to the CPBVP candidate list. The default block vector may be a zero block vector. Alternatively, the default block vector may be a block vector determined for an upper data unit such as a slice or a picture.

An encoder may encode CPBVP candidate index information indicating a CPBVP used in the current block among CPBVP candidates in the CPBVP candidate list of the current block. In addition, the encoder may encode CPBV difference information indicating a difference between an actually derived CPBV and the CPBVP.

A decoder may determine the CPBVP used for the current block among the CPBVP candidates of the CPBVP candidate list of the current block according to the CPBVP candidate index information. Then, the decoder may reconstruct the CPBV from the CPBV difference according to the CPBV difference information and the CPBV.

Hereinafter, an affine intra prediction method using merge according to one embodiment will be described. Hereinafter, the prediction method is called an affine intra merge mode.

In the affine intra merge mode of the current block, a maximum of T CPBVP candidate lists may be constructed using the neighboring blocks of the current block. Here, T is any positive integer greater than or equal to 1. The CPBVP candidates may be constructed according to an inheritance method and/or a combination method. In addition, the CPBVP candidates may include two or three CPBVs according to the affine motion model. The CPBVP candidate list may be called an affine intra merge (candidate) list.

In an inheritance method for constructing an affine intra merge list of an affine intra merge mode, embodiments of an inheritance method for constructing a CPBVP candidate list of an affine block vector prediction mode may be applied. According to an embodiment, the inheritance method of the affine intra merge mode may be determined in the same manner as the inheritance method of the affine block vector prediction mode. Alternatively, according to an embodiment, considering that the number of candidates of the CPBVP candidate list of the affine block vector prediction mode is S and the number of candidates of the affine intra merge list of the affine intra merge mode is T, which may be different from each other, the inheritance method of the affine intra merge mode and the inheritance method of the affine block vector prediction mode may be determined differently from each other.

Also, in the combination method for constructing the affine intra merge list of the affine intra merge mode, embodiments of the combination method for constructing the CPBVP candidate list of the affine block vector prediction mode, which are described based on FIG. 8, may be applied. According to the embodiment, the combination method of the affine intra merge mode may be determined in the same manner as the combination method of the affine block vector prediction mode. Alternatively, according to the embodiment, considering that the number of candidates of the CPBVP candidate list of the affine block vector prediction mode is S and the number of candidates of the affine intra merge list of the affine intra merge mode is T, which may be different from each other, the combination method of the affine intra merge mode and the combination method of the affine block vector prediction mode may be determined differently from each other.

In addition, in the affine intra merge mode, if the number of prediction candidates of the affine intra merge list generated using the inheritance method and the combination method is less than T, similarly to the affine block vector prediction mode, the translational motion vector candidates determined from CPBV1, CPBV2 and/or CPBV3 may be filled into the affine intra merge list. In addition, even if the translational motion vector candidates are added to the affine intra merge list, if the number of prediction candidates of the affine intra merge list is less than T, one or more default block vectors may be added to the affine intra merge list. The default block vector may be a zero block vector. Alternatively, the default block vector may be a block vector determined for an upper data unit such as a slice or a picture.

The encoder may encode merge index information indicating a merge candidate used for the current block among the merge candidates of the affine intra merge list of the current block in the affine intra merge mode. Unlike the affine block vector prediction mode, CPBV difference information may not be encoded.

The decoder may determine a merge candidate used for the current block among the merge candidates in the affine intra merge list of the current block according to the merge index information. Then, the CPBV of the current block may be derived from the CPBV of the merge candidate without decoding the CPBV difference information.

The encoder may encode affine intra prediction information indicating whether the affine intra prediction mode is applied. In addition, the encoder may encode affine intra prediction method information indicating which method among block vector prediction and block merge is used by the affine intra prediction mode.

The decoder may determine whether to apply the affine intra prediction mode and the type of the affine intra prediction mode according to the affine intra prediction information and the affine intra prediction method information.

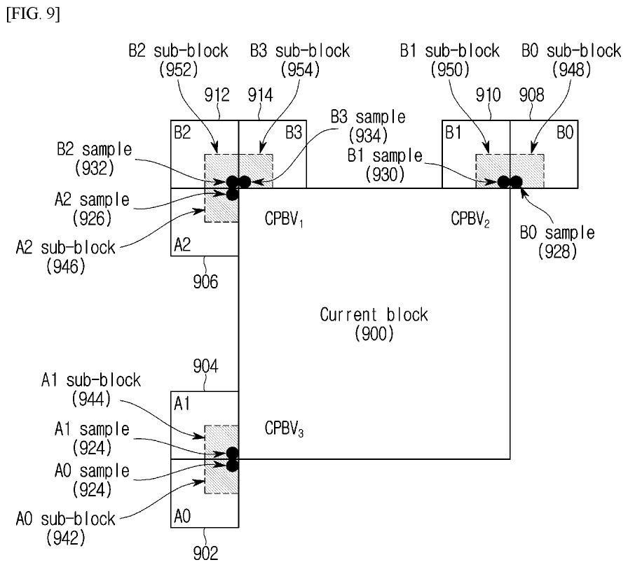

Hereinafter, a simple affine intra prediction method will be described. Simple affine intra prediction has lower complexity than the above-described affine intra prediction method. Therefore, by applying simple affine intra prediction instead of affine intra prediction to the encoder and decoder, the computational burden on the encoder and decoder can be reduced. In addition, efficient predictive encoding or predictive decoding can be implemented by adaptively applying either affine intra prediction or simple affine intra prediction on a picture or slice basis. FIG. 9 illustrates a CPBV determination method for a simple affine intra prediction. The simple affine intra prediction is performed based on a single CPBV derived from the neighboring blocks of the current block, instead of generating a CPBVP candidate list.

According to one embodiment, in order to determine CPBV1, the presence of block vectors of each block may be searched in the order of B2 block 912, B3 block 914, and A2 block 906 from the top-left of a current block 900. The block vectors may be derived from neighboring blocks encoded in the intra block copy mode or the intra template matching prediction mode. Then, a first block vector available in the order may be set to CPBV1. Whether the block vector is available is determined based on whether the block vector is used to reconstruct B2 sample 932, B3 sample 934, and A2 sample 926 of the current block. For example, if the block vector is used to reconstruct B3 sample 934 and the A2 sample 926, the block vector used to reconstruct B3 sample 934, which is earlier in the order, is determined as CPBV1.

According to another embodiment, in order to determine CPBV1, it may be searched whether the affine intra prediction mode is applied to the corresponding blocks in the order of B2 block 912, B3 block 914, and A2 block 906 from the top-left of the current block 900. Then, when the first block to which the affine intra prediction mode is applied is searched, CPBV1 may be derived from the block vector of a preset area within the first block. The preset area within B2 block 912, B3 block 914, and A2 block 906 at the top-left may be set as sub-blocks with a size of K×L (B2 sub-block 952, B3 sub-block 954, and A2 sub-block 946 indicated in gray in FIG. 9). Here, K and L are arbitrary positive integers. In addition, the block vector of the sub-block may be determined based on the center position of the sub-block. Therefore, in deriving CPBV1 of the current block from the block vector of the sub-block, CPBV1 of the current block may be determined by applying the affine model of the sub-block to the block vector of the sub-block based on a difference between the center position of the sub-block and the position of a control point of the current block.

According to another embodiment, in order to determine CPBV1, whether the affine intra prediction mode is applied to the corresponding blocks in the order of B2 block 912, B3 block 914, A2 block 906 from the top-left of the current block 900 may be first searched. Then, when the first block to which the affine intra prediction mode is applied is searched, the block vector of the preset area within the first block may be set to CPBV1. If there is no block to which the affine intra prediction mode is applied among B2 block 912, B3 block 914, and A2 block 906, the presence of block vectors may be searched in the order of B2 block 912, B3 block 914, and A2 block 906. Then, the first block vector available according to the order may be set to CPBV1.

According to one embodiment, an object to be searched for deriving CPBV1 may be determined according to CPBV search information. For example, if the CPBV search information indicates that the presence or absence of block vectors of adjacent blocks is searched for deriving CPBV, the presence or absence of block vectors for B2 block 912, B3 block 914, and A2 block 906 may be searched for deriving CPBV1 according to a predetermined search order. If the CPBV search information indicates that whether to apply the affine intra prediction mode of adjacent blocks is searched for in order to derive CPBV, whether to apply the affine intra prediction mode to B2 block 912, B3 block 914, and A2 block 906 may be searched for in a predetermined search order in order to derive CPBV1.

According to one embodiment, the CPBV search information may indicate that, in order to derive CPBV, whether the affine intra prediction mode of the adjacent block is applied is first searched, and if there is no adjacent block to which the affine intra prediction mode is applied, whether the block vector of the adjacent block is present is searched. At this time, in order to derive CPBV1, whether the affine intra prediction mode is applied to B2 block 912, B3 block 914, and A2 block 906 is searched in a predetermined search order, and if there is no adjacent block to which the affine intra prediction mode is applied, whether the block vector of B2 block 912, B3 block 914, and A2 block 906 is present may be searched in a predetermined search order.

If there is no block vector derivable from B2 block 912, B3 block 914, and A2 block 906, CPBV1 is not defined, and the information indicating whether CPBV1 is available may be set to unavailable. In the above case, CPBV1 may not be used. On the contrary, if there is a block vector derivable from B2 block 912, B3 block 914, and the A2 block 906, CPBV1 is determined from the block vector, and the information indicating whether CPBV1 is available may be set to available.

If there is no block vector derivable from B2 block 912, B3 block 914, or A2 block 906, CPBV1 may be set to have a default value.

In order to determine CPBV2 of the current block 900, it may first be searched whether there is a block vector applied to a corresponding sample in the order of B1 block 910 and B0 block 908 from the top right of the current block 900 and/or whether an affine intra prediction mode applied to a corresponding sub-block is applied. Then, the first block vector available according to the order may be set to CPBV2. Alternatively, if the first block to which the affine intra prediction mode is applied is searched, the block vector of a preset area within the first block may be set to CPBV2. The embodiment applied to CPBV1 may also be applied to CPBV2. According to the embodiment, the search order may be B0 block 908-B1 block 910.

In order to determine CPBV3 of the current block 900, it may first be searched whether there is a block vector applied to a corresponding sample in the order of A1 block 904 and A0 block 902 at the bottom-left of the current block 900 and/or whether an affine intra prediction mode applied to a corresponding sub-block is applied. Then, the first block vector available according to the order may be set to CPBV3. Alternatively, if the first block to which the affine intra prediction mode is applied is searched, the block vector of a preset area within the first block may be set to CPBV3. The embodiment applied to CPBV1 may also be applied to CPBV3. According to the embodiment, the search order may be A0 block 902-A1 block 904.

Affine intra prediction may be performed based on the determined multiple CPBVs. If two CPMVs are available at three control points (top-left, top-right, bottom-left), affine intra prediction may be performed using a 4-parameter affine motion model. For example, if CPBV1 and CPBV2 are available, affine intra prediction may be performed according to the affine motion model based on the two CPMVs. If all three CPMVs (CPBV1, CPBV2, CPBV3) of three control points are available, affine intra prediction may be performed using a 6-parameter affine motion model.

If only one CPMV is available from three control points, a general intra block copy prediction may be performed. Alternatively, if there are zero or one CPMVs available from three control points, it may be determined not to perform simple affine intra prediction without encoding information indicating whether simple affine intra prediction is applied.

The encoder may encode simple affine intra prediction information indicating whether simple affine intra prediction is applied. The decoder may determine whether simple affine intra prediction is applied according to the simple affine intra prediction information. As described above, when the number of available CPMVs is 0 or 1, it may be determined not to perform simple affine intra prediction without simple affine intra prediction information.

According to simple affine intra prediction, not only the complexity of the encoder and decoder is reduced, but also the amount of information related to the prediction method may be reduced. Therefore, the performance of the encoder and decoder can be improved by introducing simple affine intra prediction.

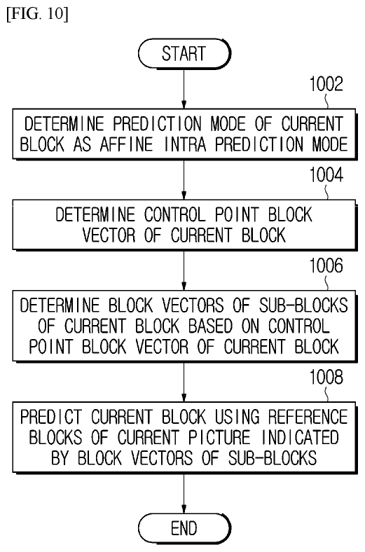

FIG. 10 illustrates an embodiment of an intra prediction method to which intra prediction mode improvement is applied.

In step 1002, a prediction mode of a current block is determined as an affine intra prediction mode.

According to one embodiment, the affine intra prediction mode may be an affine intra prediction mode using block vector prediction, in which case, an affine control point block vector predictor candidate list of the current block may be generated.

The affine control point block vector predictor candidate list may include inherited predictor candidates derived from a neighboring block, to which affine intra prediction is applied, among neighboring blocks of the current block. If the number of derived inherited predictor candidates is less than a maximum number of the affine control point block vector predictor candidate list, the affine control point block vector predictor candidate list may include a combined predictor candidate derived from a combination of block vectors of a plurality of neighboring blocks of the current block. If the number of derived inherited predictor candidates and combined predictor candidates is less than the maximum number of the affine control point block vector predictor candidate list, the affine control point block vector predictor candidate list may include a translational motion vector candidate derived from the block vector of the neighboring block of the current block.

According to one embodiment, the affine intra prediction mode may be an affine intra prediction mode using merge, in which case, an affine intra merge list of the current block may be generated.

The affine intra merge list may include inherited predictor candidates derived a neighboring block, to which affine intra prediction is applied, among the neighboring blocks of the current block. If the number of derived inherited predictor candidates is less than the maximum number of the affine intra merge list, the affine intra merge list may include combined predictor candidates derived from a combination of block vectors of a plurality of neighboring blocks of the current block. If the number of derived inherited predictor candidates and combined predictor candidates is less than the maximum number of the affine intra merge list, the affine intra merge list may include translational motion vector candidates derived from the block vector of the neighboring block of the current block.

According to one embodiment, the affine intra prediction mode may be a simple affine intra prediction mode, in which case a list including control point block vectors for prediction of the current block is not generated. Instead, a single set of control point block vectors generated by combining block vectors of adjacent blocks of the current block may be used.

In step 1004, a control point block vector of the current block is determined.

According to one embodiment, if the affine intra prediction mode is an affine intra prediction mode using block vector prediction, a control point block vector predictor may be selected from the affine control point block vector predictor candidate list of the current block. Then, the control point block vector of the current block may be determined based on the control point block vector predictor and a control point block vector difference value.

According to one embodiment, if the affine intra prediction mode is an affine intra prediction mode using merge, a control point block vector may be selected from the affine intra merge list of the current block.

According to one embodiment, if the affine intra prediction mode is a simple affine intra prediction mode, the control point block vector of the current block may be derived from an adjacent block having a block vector among adjacent blocks adjacent to the control point of the control point block vector of the current block. In addition, if the number of adjacent blocks having the block vector is greater than 1, the control point block vector of the current block may be derived according to a block vector of an adjacent block having a high priority according to a predetermined search order.

According to one embodiment, when the affine intra prediction mode is a simple affine intra prediction mode, the control point block vector of the current block may be derived from an adjacent block, to which the affine intra prediction mode is applied, among adjacent blocks adjacent to the control point of the control point block vector of the current block. In addition, if the number of adjacent blocks to which the affine intra prediction mode is applied is greater than 1, the control point block vector of the current block may be derived according to a block vector of a sub-block of an adjacent block having a high priority according to a predetermined search order.

According to one embodiment, if there is an adjacent block to which the affine intra prediction mode is applied or an adjacent block having a block vector among the adjacent blocks adjacent to the control point of the control point block vector of the current block, the control point block vector of the current block may be determined to be available. Conversely, if there is neither an adjacent block to which the affine intra prediction mode is applied nor an adjacent block having a block vector among the adjacent blocks adjacent to the control point of the control point block vector of the current block, the control point block vector of the current block may be determined to be unavailable.

If there are two available control point block vectors, the current block is predicted according to a 4-parameter affine model according to the two control point block vectors. In addition, if there are three available control point block vectors, the current block is predicted according to a 6-parameter affine model according to the three control point block vectors. Also, if there is one or less available control point block vectors, it may be determined that the affine intra prediction mode is not applied to the current block.

In step 1006, based on the control point block vector of the current block, block vectors of the sub-blocks of the current block are determined.

In step 1008, the current block is predicted using reference blocks of a current picture indicated by the block vectors of the sub-blocks.

According to the prediction method performed in steps 1002 to 1008, the current block may be encoded or decoded. In some embodiments, the affine intra prediction information, the affine intra prediction method information, the affine model flag, the CPBVP candidate index information, the CPBV difference information, the merge index information, and the simple affine intra prediction information are encoded in the encoder according to the prediction result. Then, the information is decoded in the decoder and may be used for predicting the block.

In addition, a bitstream generated by the encoder according to the prediction method performed in steps 1002 to 1008 may be stored in a recording medium or transmitted outside the encoder.

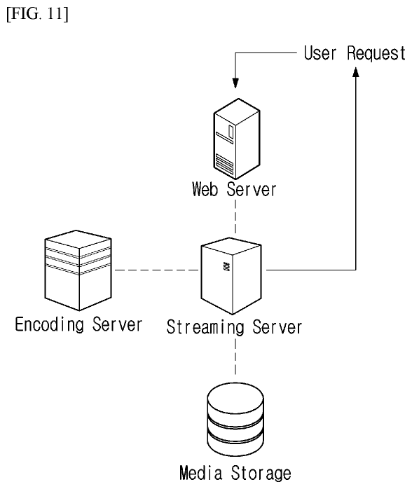

FIG. 11 exemplary illustrates a content streaming system to which an embodiment according to the present disclosure is applicable.

As illustrated in FIG. 11, a content streaming system to which an embodiment of the present disclosure is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present disclosure is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present disclosure.

Although the present disclosure has been described in terms of specific items such as detailed elements as well as the limited embodiments and the drawings, they are only provided to help more general understanding of the invention, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the invention.

### INDUSTRIAL APPLICABILITY

The present disclosure may be used in an apparatus for encoding/decoding an image and a recording medium for storing a bitstream.

1. An image decoding method comprising:
determining a prediction mode of a current block as an affine intra prediction mode;
determining a control point block vector of the current block;
determining block vectors of sub-blocks of the current block based on the control point block vector of the current block; and
predicting the current block using reference blocks of a current picture indicated by the block vectors of the sub-blocks.

2. The image decoding method of claim 1, further comprising generating an affine control point block vector predictor candidate list of the current block when the determined affine intra prediction mode is an affine intra prediction mode using block vector prediction,
wherein the control point block vector of the current block is determined from a control point block vector predictor selected from the affine control point block vector predictor candidate list of the current block.

3. The image decoding method of claim 2, wherein the affine control point block vector predictor candidate list includes inherited predictor candidates derived from a neighboring block, to which affine intra prediction is applied, among neighboring blocks of the current block.

4. The image decoding method of claim 2, wherein the affine control point block vector predictor candidate list includes combined predictor candidates derived from a combination of block vectors of a plurality of neighboring blocks of the current block.

5. The image decoding method of claim 2, wherein the affine control point block vector predictor candidate list includes a translational motion vector candidate derived from the block vector of the neighboring block of the current block if the number of inherited predictor candidates and combined predictor candidates is less than a maximum number of the affine control point block vector predictor candidate list.

6. The image decoding method of claim 2, further comprising deriving a control point block vector difference value,
wherein the control point block vector of the current block is determined based on the selected control point block vector predictor and the control point block vector difference value.

7. The image decoding method of claim 1, further comprising generating an affine intra merge list of the current block if the determined affine intra prediction mode is an affine intra prediction mode using merge,
wherein the control point block vector of the current block is determined from a control point block vector selected from the affine intra merge list of the current block.

8. The image decoding method of claim 7, wherein the affine intra merge list includes inherited predictor candidates derived from a neighboring block, to which affine intra prediction is applied, among neighboring blocks of the current block.

9. The image decoding method of claim 7, wherein the affine intra merge list includes combined predictor candidates derived from a combination of block vectors of a plurality of neighboring blocks of the current block.

10. The image decoding method of claim 7, wherein the affine intra merge list includes translational motion vector candidates derived from the block vector of the neighboring block of the current block if the number of inherited predictor candidates and combined predictor candidates is less than a maximum number of the affine intra merge list.

11. The image decoding method of claim 1, wherein if the determined affine intra prediction mode is a simple affine intra prediction mode, the control point block vector of the current block is derived from a plurality of adjacent blocks of the current block.

12. The image decoding method of claim 11,
wherein the control point block vector of the current block is derived from an adjacent block having a block vector among adjacent blocks adjacent to a control point of the control point block vector of the current block, and
wherein if the number of adjacent blocks having the block vector is greater than 1, the control point block vector of the current block is derived according to a block vector of an adjacent block having a high priority according to a predetermined search order.

13. The image decoding method of claim 11,
wherein the control point block vector of the current block is derived from an adjacent block, to which an affine intra prediction mode is applied, among adjacent blocks adjacent to a control point of the control point block vector of the current block, and
wherein if the number of adjacent blocks to which the affine intra prediction mode is applied is greater than 1, the control point block vector of the current block is derived according to a block vector of a sub-block of an adjacent block of a high priority according to a predetermined search order.

14. The image decoding method of claim 11,
wherein if there is an adjacent block to which the affine intra prediction mode is applied or an adjacent block having a block vector among the adjacent blocks adjacent to the control point of the control point block vector of the current block, the control point block vector of the current block is determined to be available, and
wherein if there is neither an adjacent block to which the affine intra prediction mode is applied nor an adjacent block having a block vector among the adjacent blocks adjacent to the control point of the control point block vector of the current block, the control point block vector of the current block is determined to be unavailable.

15. The image decoding method of claim 14,
wherein if there are two available control point block vectors, the current block is predicted according to a 4-parameter affine model according to the two control point block vectors, and
wherein if there are three available control point block vectors, the current block is predicted according to a 6-parameter affine model according to the three control point block vectors.

16. The image decoding method of claim 14, wherein if there is one or less available control point block vectors, it is determined that the affine intra prediction mode is not applied to the current block.

17. An image encoding method comprising:
determining a prediction mode of a current block as an affine intra prediction mode;
determining a control point block vector of the current block;
determining block vectors of sub-blocks of the current block based on the control point block vector of the current block; and
predicting the current block using reference blocks of a current picture indicated by the block vectors of the sub-blocks.

18. (canceled)

19. A method of transmitting a bitstream generated by an image encoding method, the method comprising:
encoding an image based on the image encoding method; and
transmitting the bitstream including the encoded image,
wherein the image encoding method comprises:
determining a prediction mode of a current block as an affine intra prediction mode;
determining a control point block vector of the current block;
determining block vectors of sub-blocks of the current block based on the control point block vector of the current block; and
predicting the current block using reference blocks of a current picture indicated by the block vectors of the sub-blocks.
